(19) United States
(12) Patent Application Publication
(10) Pub. No.: US 2019/0162419 A1
(43) Pub. Date: May 30, 2019

(54) PRESSING ELEMENT AND INDUCTION HOB COMPRISING A PRESSING ELEMENT

(71) Applicant: ELECTROLUX APPLIANCES AKTIEBOLAG, Stockholm (SE)

(72) Inventors: Alwin NEUKAMM, Rothenberg ob der Tauber (DE); Juergen LEIKAM, Rothenberg ob der Tauber (DE); Gerhard KLEIN, Rothenberg ob der Tauber (DE); Björn LEYH, Rothenberg ob der Tauber (DE)

(21) Appl. No.: 16/320,768

(22) PCT Filed: Jul. 28, 2017
(86) PCT No.: PCT/EP2017/069223

§ 371 Date: Jan. 25, 2019

(30) Foreign Application Priority Data
Aug. 16, 2016 (EP) 16184304.0

(51) Int. Cl. F24C 15/10; H05B 6/12; H05B 6/06; F16F 1/12

(52) U.S. Cl. CPC F24C 15/107; F24C 15/102; H05B 6/1245; F16F 2230/0005; F16F 1/128; F16F 2226/04; H05B 6/062

(57) ABSTRACT

The invention relates to a pressing entity (1) for pressing an induction heating unit (10) against a hob plate, the pressing entity (1) comprising: —a spring element (2); —a coupling element (3), said coupling element (3) being adapted to detachably couple the pressing entity (1) with the induction heating unit (10); wherein the coupling element (3) comprises a spring coupling portion (3.1) adapted to receive the spring element (2), said spring coupling portion (3) being adapted to receive the spring element (2) such that a portion of the spring element (2) protrudes out of the coupling element (3).

The present invention relates generally to the field of pressing elements. More specifically, the present invention is related to a pressing element adapted to press an induction heating unit of an induction hob against a hob plate.

### BACKGROUND OF THE INVENTION

Induction hobs for preparing food are well known in prior art. Induction hobs typically comprise at least one induction coil placed below a hob plate in order to heat a piece of cookware.

In order to increase the efficiency of inductive coupling between the piece of cookware and the induction coil, the distance between the hob plate and the induction coil should be as low as possible.

European Patent Application EP 2 975 289 A2 discloses an induction hob comprising pressing entities for pressing the induction coil against the hob plate.

A drawback of the known solution is that the pressing entities comprise a complex structure and mounting of the pressing entity at the induction heating unit is difficult.

### SUMMARY OF THE INVENTION

It is an objective of the embodiments of the invention to provide a pressing entity with a simple structure which enables a technically simple integration into the induction hob, thereby reducing the assembling effort. The objective is solved by the features of the independent claims. Preferred embodiments are given in the dependent claims. If not explicitly indicated otherwise, embodiments of the invention can be freely combined with each other.

According to an aspect, the invention relates to a pressing entity for pressing an induction heating unit against a hob plate. The pressing entity comprises a spring element and a coupling element. Said coupling element is adapted to detachably couple the pressing entity with the induction heating unit. The coupling element comprises a spring coupling portion adapted to receive the spring element. Said spring coupling portion is adapted to receive the spring element such that a portion of the spring element protrudes out of the coupling element.

Said pressing entity is advantageous because the number of parts of the pressing entity is reduced and—due to the usage of the coupling element which connects the pressing element with the induction heating unit, specifically a support plate of the induction heating unit—the assembling of the induction hob is significantly simplified.

According to embodiments, the spring coupling portion comprises a recess for receiving a portion of said spring element. Within said recess, for example, a free end of a spring element may be received whereas the other free end protrudes out of the coupling element. Thereby, the connection between the coupling element and the spring element is simplified.

According to embodiments, the spring element is a compression spring, specifically a compression spiral spring. Thereby, by placing the protruding free end of the spring element on a counter-bearing portion (e.g. a housing portion) and compressing the spring element, an induction heating unit operatively coupled with the coupling element of the pressing entity and including one or more induction coils can be pressed against the hob plate.

According to embodiments, a first free end of the spring element is arranged within the coupling element and a second free end protrudes out of the coupling element. Thereby, the structure of the pressing entity is simplified because no spring-operated pressing pin is required.

According to embodiments, the spring coupling portion comprises spring fixing means for fixing a spring element portion, specifically a first free end of the spring element in the spring coupling portion. Thereby, an undesired falling out of the spring element, for example, during assembling or maintenance is avoided.

According to embodiments, said spring fixing means comprise hook-shaped protrusions being adapted to engage into a coil of the spring element. Said hook-shaped protrusions may comprise hook portions which provide a snap connection between the spring element and the coupling element. Thereby, a technically simple fixing of the spring element within the coupling element is obtained.

According to embodiments, said spring fixing means, specifically the hook-shaped protrusions, radially protrude into the spring coupling portion. Said hook-shaped protrusions may be deformable or bendable in order to enable an insertion of the spring element into the spring coupling portion. In other words, a snap or click connection between the spring element and the coupling element is provided. Thereby, a secure fixing of the spring element within the coupling element is obtained.

According to other embodiments, the spring fixing means comprise a thread adapted to interact with the coils of the spiral spring in order to screw the spiral spring with the coupling element.

According to embodiments, the coupling element is adapted to be inserted into an opening or recess provided within the induction heating unit. Thereby, a technically simple coupling between the induction heating unit and the pressing element is obtained.

According to embodiments, the coupling element comprises an outer cross section being adapted to the cross section of the opening or recess provided within the induction heating unit. For example, the cross section of the coupling element comprises a circular shape or arc-shaped portions in order to be received in a circular opening or recess of the induction heating unit. Thereby, the coupling element is centred within said opening or recess.

According to embodiments, the coupling element comprises fixing means engaging into a section of the induction heating unit for fixing the coupling element at the induction heating unit. More specifically, the section of the induction heating unit may be an edge of the opening or an edge or aperture provided within a recess of the induction heating unit. Thereby, the coupling element is securely mounted at the induction heating unit.

According to embodiments, said fixing means comprise one or more hook-shaped protrusions which are adapted to engage into or behind a section of the induction heating unit. More in detail, said hook-shaped protrusions are adapted to engage behind an edge of an opening of the induction heating unit. Thereby, the coupling element is releasably but securely mounted at the induction heating unit.

According to embodiments, said coupling element comprises a radially protruding collar forming a contact surface being adapted to rest against a planar portion close to the opening or recess of the induction heating unit. The planar portion may be a support plate, also referred to as coil carrier, provided at the induction heating unit. Said collar may provide a support on which the induction heating unit rests on in the installed position. Said collar may comprise an annular shape or may have two or more arc-shaped portions circumferentially arranged at the coupling element.

According to embodiments, the one or more hook-shaped protrusions are adapted to engage behind an edge of the opening or recess when the collar rests against the planar portion of the induction heating unit. In other words, the collar and the hook-shaped protrusions may be arranged at opposite sides of the planar portion thereby mounting the pressing entity by a click connection at the induction heating unit.

According to embodiments, the coupling element comprises a contact portion forming a poka-yoke portion or poka-yoke element. In other words, the contact portion may be an asymmetric portion, for example, an asymmetric protrusion which ensures a desired integration of the pressing element and therefore a desired assembling of the induction hob.

According to a second aspect, the invention relates to an induction hob comprising an induction heating unit including one or more induction coils and a hob plate. The induction heating unit comprises one or more pressing entities as described before in order to press the induction heating unit, specifically the one or more induction coils or an isolation layer placed above the one or more induction coils against the hob plate.

The term “induction heating unit” as used in the present disclosure refers to an entity comprising at least one induction coil, preferably at least two induction coils. The entity preferably further comprises a support plate, also referred to as coil carrier. Preferably, the induction coil(s) may be attached to the top side of the support plate. The entity preferably further comprises at least one isolation layer, particularly at least one mica layer sheet. The isolation layer, particularly the mica layer sheet may cover at least one induction coil, particularly each isolation layer may cover at least two induction coils.

The term “essentially” or “approximately” as used in the invention means deviations from the exact value by +/−10%, preferably by +/−5% and/or deviations in the form of changes that are insignificant for the function.

### BRIEF DESCRIPTION OF THE DRAWINGS

The various aspects of the invention, including its particular features and advantages, will be readily understood from the following detailed description and the accompanying drawings, in which:

FIG. 1 shows an example embodiment of a pressing entity in a first perspective view;

FIG. 2 shows an example embodiment of a pressing entity in a second perspective view;

FIG. 3 shows parts of an induction hob, namely an isolation layer arranged above an induction heating unit including pressing entities in a first perspective view;

FIG. 4 shows a sectional view of the induction heating unit of FIG. 3 including a pressing entity;

FIG. 5 shows parts of an induction hob, namely an isolation layer arranged at an induction heating unit including pressing entities in a second perspective view; and

FIG. 6 shows a sectional view of the induction heating unit of FIG. 5 including a pressing entity.

### DETAILED DESCRIPTION OF PREFERRED EMBODIMENTS

The present invention will now be described more fully with reference to the accompanying drawings, in which example embodiments are shown. However, this invention should not be construed as limited to the embodiments set forth herein. Throughout the following description similar reference numerals have been used to denote similar elements, parts, items or features, when applicable.

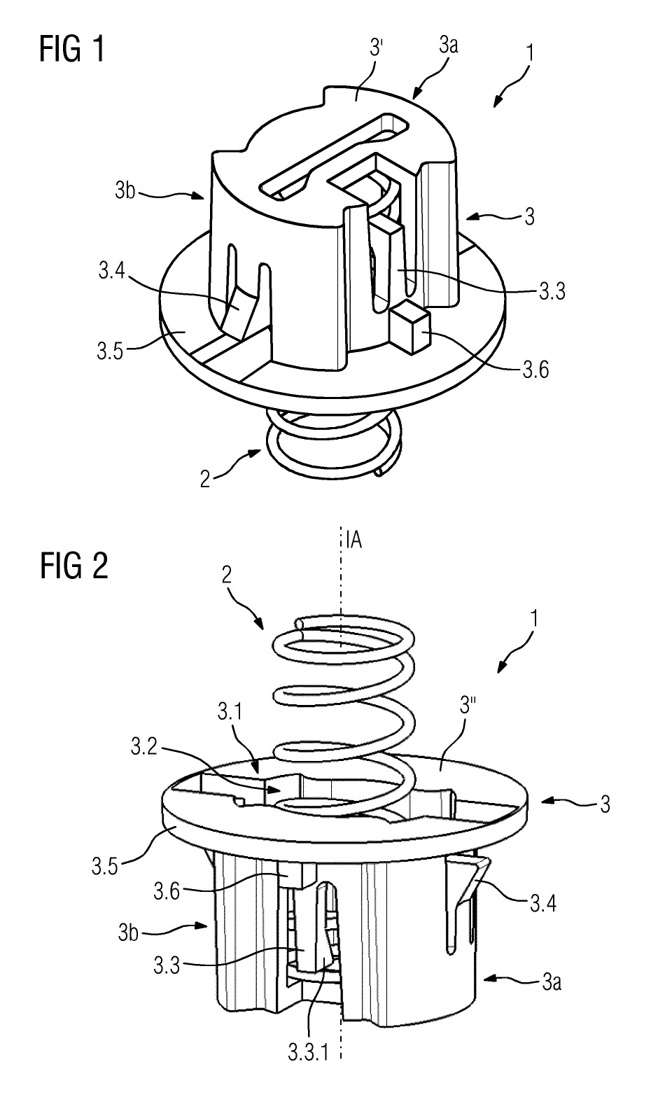

FIGS. 1 and 2 show an example embodiment of a pressing entity 1 according to the invention. The pressing element 1 may be used within an induction hob for pressing an induction heating unit against the hob plate.

More in detail, the pressing element 1 comprises a spring element 2 and a coupling element 3 which is used for coupling the spring element with an induction heating unit comprising one or more induction coils.

As shown in FIGS. 1 and 2, the coupling element 3 comprises a hat-like shape with an upper side 3′ and a lower side 3″. On the one hand, the coupling element 3 is adapted to receive a section of the spring element 2. On the other hand, the coupling element 3 itself is adapted to be received within an opening or recess of the induction heating unit in order to enable a pressing of the induction heating unit against a hob plate by means of said spring element 2. Said coupling element 3 may be releasably coupled with the induction heating unit by a click or snap connection.

As shown in FIG. 2, the coupling element 3 comprises a spring coupling portion 3.1 adapted to receive a portion of the spring element 2. In the present embodiment, the spring element 2 is a spiral spring, specifically a spiral compression spring. The spring coupling portion 3.1 may be a recess 3.2 which is formed within the coupling element 3. Due to said recess 3.2, the coupling element 3 may have a sleeve-like shape.

Said recess 3.2 is adapted to receive a portion of the spring element 2, specifically a free end portion of the spring element 2. The depth of the recess 3.2 is chosen such that the second free end of the spring element 2 protrudes out of the lower side 3″ of the coupling element 3. The recess 3.2 may be adapted to receive the spring element 2 in a form-fitted manner.

In order to avoid that the spring element 2 falls out of the coupling element 3, the coupling element 3 comprises spring fixing means adapted to secure the spring element 2 in the partly inserted position. In the present embodiment, the spring fixing means comprise one or more hooks or hook-shaped protrusions 3.3. Preferably, one or more pairs of hook-shaped protrusions 3.3 are arranged at opposite sides of the recess 3.2. The hook-shaped protrusions 3.3 may extend along an insertion axis IA and may comprise hook portions 3.3.1 which protrude into the recess 3.2. In case of a spring element 2 inserted into the recess 3.2, said hook portions 3.3.1 interact with the coils or windings of the spring element 2 thereby fixing the spring element 2 within the recess 3.2. More in detail, the hook portions 3.3.1 engage with a coil or winding of the spring element 2 (cf. FIG. 2). The hook portions 3.3.1 may be at least partially flexible in order to be bent outwardly when inserting the spring element 2.

According to other embodiments, the spring fixing means may comprise a thread which corresponds with the coils of the spring element 2. Thus, the spring element 2 may be fixed within the recess 3.2 by screwing the spring element 2 into the recess 3.2. Also, other spring fixing means may be possible.

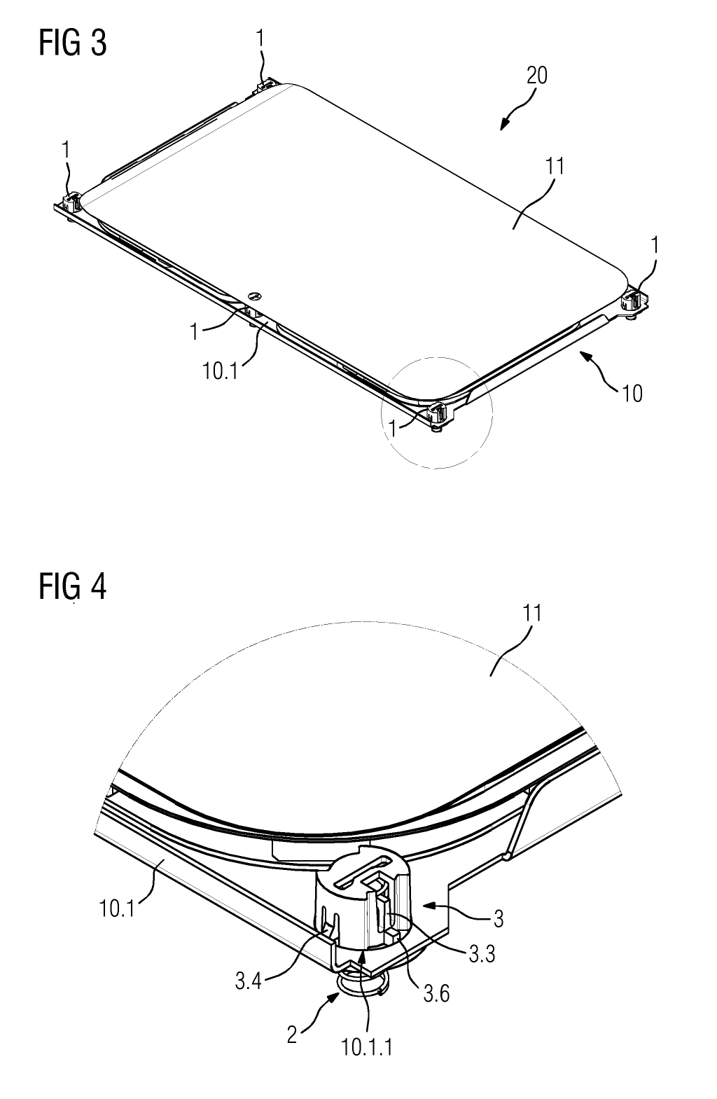

FIG. 3 shows a schematic illustration of an induction hob 20. The induction hob 20 comprises at least one heating zone, preferably provided at a hob plate (not shown in FIGS. 3 to 6). The induction hob may comprise one or more isolation layers 11, beneath which one or more induction coils are provided. The isolation layer 11 may be, for example, a mica layer. Said one or more induction coils are arranged at a support plate 10.1 of an induction heating unit 10. One or more pressing entities 1 are arranged at the induction heating unit 10 in order to press the induction heating unit 10 comprising the induction coils against the hob plate. More in detail, the pressing entities 1 may, for example, rest with its spring elements 2 at a frame of a power board unit or a housing of said power board unit. Preferably, by means of said pressing entities 1, an induction unit assembly comprising the support plate 10.1, the one or more induction coils and the at least one isolation layer 11 is pressed against the hob plate.

As shown in FIGS. 3 to 6, the induction heating unit 10, specifically the support plate 10.1 of an induction heating unit 10 comprises one or more openings 10.1.1 which are adapted to receive the coupling element 3 of the pressing entity 1. For example, the coupling element 3 may be inserted with its top portion provided at the upper side 3′ into said opening 10.1.1 and may be fixed into said opening 10.1.1 in order to avoid an undesired falling out of the pressing entity 1.

More in detail, the coupling element 3 may comprise a cross section (in a plane perpendicular to the insertion axis IA) which is adapted to the geometry of the opening 10.1.1 in order to receive the coupling element 3 within the opening 10.1.1. Said receiving may be implemented in a at least partially form-fitted, centred manner. According to the present embodiment, the coupling element 3 comprises a pair of arc-shaped portions 3a, 3b which are preferably arranged at opposite sides. In addition, one or more further contact portions 3.6 may be provided for achieving a form-fitted and/or centred arrangement within the opening 10.1.1. The contact portion 3.6 may form a poka-yoke portion ensuring that the pressing entity 1 can only be attached in a certain installation position at the support plate 10.1. With respect to a central axis (e.g. the insertion axis IA), the arc-shaped portions 3a, 3b comprise a radius which is equal or essentially equal to the radius of the opening 10.1.1. Alternatively, a complete circular shape of the cross-section of the coupling element 3 may be possible. In other embodiments, the opening 10.1.1 may comprise an oval or polygon shape and the cross-sectional shape of the coupling element 3 may be adapted to the shape of the opening 10.1.1.

At the lower side 3″, specifically at the lower edge, the coupling element 3 comprises a collar 3.5. The collar 3.5 is formed at the circumferential surface of the coupling element 3 and protrudes radially from said circumferential surface. Said collar 3.5 forms a contact surface which rests against the support plate 10.1 close to the opening 10.1.1. Thereby, a resilient contact of the coupling element 3 at the support plate 10.1 is achieved. In installation position, the collar 3.5 may rest against the bottom surface of the support plate 10.1.

In order to avoid an undesired falling of the pressing entity 1 out of the induction heating unit 10, the coupling element 3 may comprise fixing means adapted to secure the coupling element 3 at the induction heating unit 10. Said fixing means may comprise one or more portions engaging behind the edge of the opening 10.1.1 at the opposite side of the collar 3.5 thereby realizing a secure mounting of the coupling element 3 at the induction heating unit 10. In the present embodiment, said fixing means are formed by hook-shaped protrusions 3.4. Said hook-shaped protrusions 3.4 or hooks may protruding radially outwardly from the circumferential surface of the coupling element 3 in an area slightly above the collar 3.5 in order to be able to engage being the edge of the opening 10.1.1 when inserting the pressing entity 1 in the support plate 10.1. Said hook-shaped protrusions 3.4 may be adapted to be bent radial inwardly in order to enable the pressing entity 1 to be inserted in the opening 10.1.1.

According to other embodiments, the coupling element 3 may comprise a thread for fixing the pressing entity 1 at the support plate 10.1. It is worth mentioning that also other fixing means may be possible.

The coupling element 3 may be made of an electrically non-conductive material, specifically plastic. Thereby, an electrical isolation between the induction heating unit 10 and the element or portion, on which the free end of the spring element 2 rests on (e.g. a housing portion) is possible.

FIGS. 3 to 6 show the induction heating unit 10 comprising multiple pressing entities 1 which are adapted to press the induction coils arranged at the support plate 10.1 of the heating unit 10 against the hob plate. The induction coils may directly positioned at the hob plate or an intermediate isolation layer 11 may be arranged between the induction coils and the hob plate.

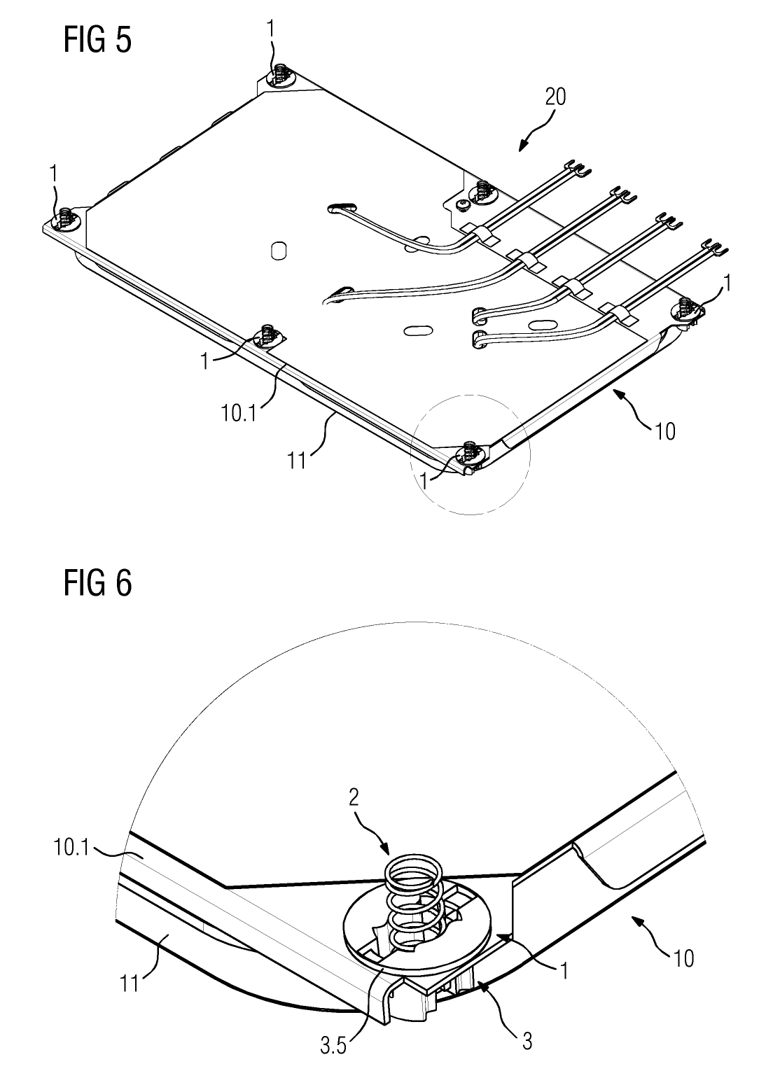

As best seen in FIGS. 4 and 6, the coupling element 3 is inserted into the opening 10.1.1 until the collar 3.5 rests against the support plate 10.1. In said inserted position, the hook-shaped protrusions 3.4 engage behind the opening edge in order to secure the pressing entity 1 at the support plate 10.1. In said inserted position, the spring element 2 protrudes from the lower side of the support plate 10.1. By placing the induction heating unit 10 in a housing or on a frame of a power unit, for example, the spring elements 2 are at least partially compressed thereby pressing the induction heating unit 10 against the hob plate.

It should be noted that the description and drawings merely illustrate the principles of the proposed pressing entity, respectively induction hob. Those skilled in the art will be able to implement various arrangements that, although not explicitly described or shown herein, embody the principles of the invention.

### LIST OF REFERENCE NUMERALS

1 pressing entity

2 spring element

3 coupling element

3′ upper side

3″ lower side

3a, 3b arc-shaped portion

3.1 spring coupling portion

3.2 recess

3.3 hook-shaped protrusion

3.3.1 hook portion

3.4 hook-shaped protrusion

3.5 collar

3.6 contact portion

10 induction heating unit

10.1 support plate

10.1.1 opening

11 isolation layer

20 induction hob

IA insertion axis

1. Pressing entity for pressing an induction heating unit against a hob plate, the pressing entity comprising:
a spring element;
a coupling element, said coupling element being adapted to detachably couple the pressing entity with the induction heating unit;
wherein the coupling element comprises a spring coupling portion adapted to receive the spring element, said spring coupling portion being adapted to receive the spring element such that a portion of the spring element protrudes out of the coupling element.

2. Pressing entity according to claim 1, wherein the spring coupling portion comprises a recess for receiving a portion of said spring element.

3. Pressing entity according to claim 1, wherein the spring element is a compression spring.

4. Pressing entity according to claim 1, wherein a first free end of the spring element is arranged within the coupling element and a second free end of the spring element protrudes out of the coupling element.

5. Pressing entity according to claim 1, wherein the spring coupling portion comprises spring fixing means for fixing a first free end of the spring element in the spring coupling portion.

6. Pressing entity according to claim 5, wherein said spring fixing means comprise hook-shaped protrusions adapted to engage into a coil of the spring element.

7. Pressing entity according to claim 6, wherein said hook-shaped protrusions radially protrude into the spring coupling portion.

8. Pressing entity according to claim 1, wherein the coupling element is adapted to be inserted into an opening or recess provided within the induction heating unit.

9. Pressing entity according to claim 8, wherein the coupling element comprises an outer cross section adapted to a cross section of the opening or recess provided within the induction heating unit.

10. Pressing entity according to claim 8, wherein a cross section of the coupling element comprises a circular shape or arc-shaped portions in order to be received in the circular opening or recess of the induction heating unit.

11. Pressing entity according to claim 1, wherein the coupling element comprises fixing means engaging into a section of the induction heating unit for fixing the coupling element at the induction heating unit.

12. Pressing entity according to claim 11, wherein said fixing means comprise one or more hook-shaped protrusions adapted to engage into or behind a section of the induction heating unit.

13. Pressing entity according to claim 9, wherein the coupling element comprises a radially protruding collar forming a contact surface being adapted to rest against a planar portion close to the opening or recess of the induction heating unit.

14. Pressing entity according to claim 13, said spring fixing means comprising hook-shaped protrusions adapted to engage into a coil of the spring element, wherein the one or more hook-shaped protrusions are adapted to engage behind an edge of the opening or recess when the collar rests against the planar portion of the induction heating unit.

15. Induction hob comprising an induction heating unit comprising one or more induction coils and a hob plate, the induction heating unit comprising the pressing entity according to claim 1 in order to press the induction heating unit against the hob plate.

16. A pressing entity for pressing an induction heating unit against a hob plate, the pressing entity comprising:
an coupling element adapted to be inserted through an opening in a support plate of the induction heating unit, the coupling element having a recess therein and a collar extending radially from an opening of said recess, a first flexible hook-shaped protrusion of said coupling element at least partially protruding inwardly into said recess, and a second flexible hook-shaped protrusion of said coupling element protruding outward from a circumferential surface thereof and spaced axially from said collar so as to define a receiving space between said second hook-shaped protrusion and said collar; and
a compression spring partially received within said recess through said opening such that a free end of the compression spring extends outside said recess beyond said collar;
said first flexible hook-shaped protrusion being configured such that upon insertion of said compression spring into said recess the first flexible hook-shaped protrusion bends outwardly to make way for said insertion of said spring, and such that the first flexible hook-shaped protrusion resumes its inward-protruding position in said recess once the spring has been inserted so as to interact with coils or windings of the spring in order to retain the spring within the recess;
said second flexible hook-shaped protrusion being configured such that upon insertion of said coupling element through said opening in said support plate the second flexible hook-shaped protrusion bends inward to make way therefor until a portion of said support plate surrounding the opening therein reaches said receiving space, whereupon said second flexible hook-shaped protrusion resumes its radially outward-protruding position so as to confine said portion of said support plate in the receiving space between said collar and the second flexible hook-shaped protrusion.

17. The pressing entity according to claim 16, said coupling element being made of electrically non-conductive material.

18. The pressing entity according to claim 16, said coupling element comprising a pair of said first flexible hook-shaped protrusions at least partially protruding inwardly into and arranged at opposite sides of the recess, and a pair of said second flexible hook-shaped protrusion protruding outward from and arranged at opposite sides of said circumferential surface and spaced axially from said collar so as to define said receiving space.
